(19) United States
(12) Patent Application Publication
(10) Pub. No.: US 2007/0064010 A1
(43) Pub. Date: Mar. 22, 2007

(54) DISPLAY APPARATUS AND CONTROL METHOD THEREOF

(76) Inventors: Young-chan Kim, Ulwang-si (KR); Yun-ju Hong, Suwon-si (KR); In-hye Lee, Suwon-si (KR)

Correspondence Address: STANZIONE & KIM, LLP, 919 18TH STREET, N.W., SUITE 440, WASHINGTON, DC, 20006, US

(21) Appl. No.: 11/533,575

(22) Filed: Sep. 20, 2006

(30) Foreign Application Priority Data
Sep. 21, 2005 (KR) 2005-87765

(51) Int. Cl. G09G 5/02

(52) U.S. Cl. 345/597

(57) ABSTRACT

A display apparatus to display unit an image corresponding to an image signal provided from an external information processing apparatus, includes a nonvolatile memory having a first data area and a second data area to store data to adjust a display state of the displayed image and a program code area to store program codes, an image processing unit to process the image signal based on the data stored in one of the first data area and the second data area, and a micro control unit to control the image processing unit to process the image signal based on the data stored in the other of the first data area and the second data area when the data stored in the one of the first data area and the second data area are updated and when the update operation is abnormally ended.

### CROSS-REFERENCE TO RELATED APPLICATIONS

This application claims priority under 35 U.S.C. §119(a) from Korean Patent Application No. 2005-0087765, filed on Sep. 21, 2005, in the Korean Intellectual Property Office, the disclosure of which is incorporated herein by reference in its entirety.

### BACKGROUND OF THE INVENTION

1. Field of the Invention

The present general inventive concept relates to a display apparatus and a control method thereof, and more particularly, to a display apparatus in which, if one of first and second data areas in which color data are stored is abnormally updated, color data stored in the other data area corresponding to a backup area are used to display normal images.

2. Description of the Related Art

In general, a display apparatus processes an image signal provided from a signal source, such as an external information processing apparatus (for example, a computer), to generate an image observable by a user. The image signal provided from the signal source (which may have, for example, a gray mode, an RGB mode, or a CYMK mode) is adjusted with respect to a gain (i.e., signal strength) for each color thereof through predetermined signal processing in the display apparatus, such that the image having a variety of colors is displayed on a display unit of the display apparatus.

With an increase in a demand for high-definition display apparatuses, there has been a need to adjust colors of images displayed in a display apparatus in order to obtain optimal moving pictures for multimedia, and accordingly, massive amounts of color data have been required. In addition, there is an increasing need to handle colors of images displayed in a display apparatus in order to match colors of an image displayed in the display apparatus with colors of an image printed on a paper.

Color data of an image displayed on a display unit of a display apparatus may be detected by a separate sensor. When a large quantity of color data are to be updated to adjust colors of the image displayed on the display unit based on the color data detected by the sensor, a separate memory, such as an EEPROM (Electrically Erasable Programmable Read Only Memory), for storing the large quantity of color data is provided in the display apparatus.

In addition, a specified area of a built-in RAM of a micro control unit for driving parts of the display apparatus is assigned as a color data area, and the color data are collectively loaded and updated from the separate memory into the color data area, thereby increasing a speed at which the color data is updated. In this case, an update operation may be performed using a separate RAM other than the built-in RAM of the micro control unit.

Referring to FIG. 1, in a conventional display apparatus, a flash ROM 100 is provided as a nonvolatile memory in a micro control unit and is divided into a program code area (in which program codes for driving the display apparatus are stored) and a remaining area. Whether or not the program codes stored in the program code area are damaged is checked using data checksum values of the flash ROM 100 during manufacture of the display apparatus or during an after-sales service after product shipping.

However, in such a conventional display apparatus, a separate EEPROM used to store color data is accompanied by an increase in costs and lowering of speed of update operations of the color data. In addition, in the case of a built-in (or separate) RAM of the micro control unit in the display apparatus, since a specified area is assigned as a color data area 110b in addition to a general RAM area 110a for processing general data, as illustrated in FIG. 1, a work space for other required processes may be insufficient.

In addition, while the conventional display apparatus is performing the update operation of the color data, the update operation may be abnormally stopped due to an abrupt power off of an external information processing apparatus to provide color data for color data update or an abrupt power off of the display apparatus itself. In this case, since the conventional display apparatus may process an image signal based on partially updated color data of the overall color data, there may arise a problem of a display of an abnormal image.

### SUMMARY OF THE INVENTION

The present general inventive concept provides a display apparatus without a separate external memory, in which a performance speed is increased with respect to a color adjustment by assigning a color data area in a nonvolatile memory provided in a micro control unit, and a control method thereof.

The present general inventive concept provides a display apparatus in which, if one of first and second data areas in which color data are stored is abnormally updated, color data stored in the other data area corresponding to a backup area are used to display normal images, and a control method thereof.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a display apparatus to display an image corresponding to an image signal provided from an external information processing apparatus, comprising a nonvolatile memory comprising a first data area and a second data area to store data to adjust a display state of the displayed image, and a program code area to store program codes, an image processing unit to process the image signal based on the data stored in one of the first data area and the second data area, and a micro control unit to control the image processing unit to process the image signal based on the data stored in the other of the first data area and the second data area when the data stored in the one of the first data area and the second data area are updated in an update operation that is abnormally ended.

The nonvolatile memory may comprise a flash ROM.

The flash ROM may be provided in the micro control unit.

The data stored in the first data area and the second data area may be predetermined color data.

The micro control unit updates the color data stored in one of the first data area and the second data area by the external information processing apparatus.

The display apparatus may further comprise a predetermined memory, and the micro control unit may store name information and update start state information of a data area to be updated of the first data area and the second data area in the predetermined memory when a pattern signal to update the color data stored in the data area to be updated is provided from the external information processing apparatus.

The micro control unit may control the image processing unit to process the image signal based on the pattern signal.

The predetermined memory may be an EEPROM.

The micro control unit may determine whether the update operation is normally ended when the update of the color data is ended, and may change the update start state information stored in the EEPROM to update end state information when it is determined that the update operation is normally ended.

The micro control unit may control the image processing unit to process the image signal based on the data of the updated data area corresponding to the name information stored in the EEPROM when the update end state information is stored in the EEPROM.

The micro control unit may control the image processing unit to process the image signal based on the data of the other data area that is not updated when it is determined that the update operation is abnormally ended.

The micro control unit may control the image processing unit to process the image signal based on the color data of the updated data area corresponding to the name information stored in the EEPROM when the update end state information is read from the EEPROM at an initial driving stage.

The micro control unit may pre-store a first reference check sum value of the first data area and a second reference check sum value of the second data area, may calculate a check sum value of the updated data area corresponding to the name information stored in the EEPROM when the update start state information is read from the EEPROM at an initial driving stage, and may change the update start state information stored in the EEPROM to the update end state information when the calculated check sum value is equal to a corresponding one of the first and second reference check sum values.

The micro control unit may change the update start state information stored in the EEPROM to update failure state information when the calculated check sum value is not equal to the corresponding one of the first and second reference check sum values.

The micro control unit may control the image processing unit to process the image signal based on the data of the other data area that is not updated when the update failure state information is stored in the EEPROM.

The micro control unit controls the image processing unit to process the image signal based on color data of the other data area that is not updated when the update failure state information is read from the EEPROM at the initial driving stage.

The foregoing and/or other aspects and utilities of the present general inventive concept may also be achieved by providing a control method of a display apparatus to display an image corresponding to an image signal provided from an external information processing apparatus, the display apparatus having a nonvolatile memory including a first data area and a second data area to store data to adjust of a display state of the displayed image and a program code area to store program codes, and an image processing unit to process the image signal, the control method comprising updating the data stored in one of the first data area and the second data area, determining whether the update operation is abnormally ended, and controlling the image processing unit to process the image signal based on the data stored in the other of the first data area and the second data area when the update operation is determined to be abnormally ended.

The nonvolatile memory may comprise a flash ROM.

The flash ROM may be provided in a micro control unit.

The data stored in the first data area and the second data area may be predetermined color data.

The control method, wherein the display apparatus may further includes a predetermined memory, and the method may further comprise determining whether a pattern signal to update the data stored in the one of the first data area and the second data area is provided from the external information processing apparatus, and storing name information and update start state information of a data area to be updated of the first data area and the second data area in the predetermined memory when the pattern signal is provided.

The control method may further comprise controlling the image processing unit to process the image signal based on the pattern signal when the pattern signal is provided.

The predetermined memory may be an EEPROM.

The updating of the data may comprise updating the data stored in the one of the first data area and the second data area by the external information processing apparatus.

The control method may further comprise changing the update start state information stored in the EEPROM to update end state information when it is determined that the update operation is normally ended.

The control method may further comprise controlling the image processing unit to process the image signal based on the color data of the updated data area corresponding to the name information stored in the EEPROM when the update end state information is stored in the EEPROM.

The control method may further comprise reading an update state information stored in the EEPROM at an initial driving stage, and controlling the image processing unit to process the image signal based on the data of the updated data area corresponding to the name information stored in the EEPROM when the update end state information is read from the EEPROM.

The control method may further comprise pre-storing a first reference check sum value of the first data area and a second reference check sum value of the second data area, calculating a check sum value of the updated data area corresponding to the name information stored in the EEPROM when the update start state information is read from the EEPROM at the initial driving stage, determining whether the calculated check sum value is equal to a corresponding one of the first and second reference check sum values, and changing the update start state information stored in the EEPROM to the update end state information when it is determined that the calculated check sum value is equal to the corresponding one of the first and second reference check sum values.

The control method may further comprise changing the update start state information stored in the EEPROM to update failure state information when it is determined that the calculated check sum value is not equal to the corresponding one of the first and second reference check sum values.

The control method may further comprise controlling the image processing unit to process the image signal based on the data of the other data area that is not updated when the update failure state information is stored in the EEPROM.

The control method may further comprise controlling the image processing unit to process the image signal based on the data of the other data area that is not updated when the update failure state information is read from the EEPROM at the initial driving stage.

The foregoing and/or other aspects and utilities of the present general inventive concept may also be achieved by providing a display apparatus to display an image, comprising a non-volatile internal memory unit having a plurality of updatable data areas to store updatable image data, and a non-updatable default area to store non-updatable reference image data, and an adjusting unit to adjust a characteristic of the displayed image using the updatable image data stored in one of the plurality of updatable data areas of the non-volatile internal memory unit.

The adjusting unit may adjust the characteristic of the displayed image using updated data from a first data area of the plurality of updatable data areas when the first data area has been successfully updated, and using non-updated data from a second data area of the plurality of updatable data areas when the first data area has been unsuccessfully updated. The characteristic to be adjusted may be a color characteristic. The display apparatus may further comprise a micro control unit to control the adjusting unit to adjust the characteristic of the displayed image, the non-volatile internal memory unit may include a program code area to store a program code, and the micro control unit may control the adjusting unit using the program code stored in the program code area of the non-volatile internal memory unit. The non-volatile internal memory unit may be located in the micro control unit. The display apparatus may further comprise a storage unit to store identification information corresponding to an updatable data area of the plurality of updatable data areas to be updated.

The foregoing and/or other aspects and utilities of the present general inventive concept may also be achieved by providing a display system to display an image, comprising a display device to process an image signal corresponding to the image, the display device comprising a non-volatile internal memory unit having a plurality of updatable data areas to store updatable image data, and a non-updatable default area to store non-updatable reference image data, and an adjusting unit to adjust a characteristic of the displayed image using the updatable image data stored in one of the plurality of updatable data areas of the non-volatile internal memory unit, an external signal generating device to generate the image signal, and a sensing unit to sense image data corresponding to the characteristic to be adjusted in the non-volatile internal memory unit, and to generate a signal to adjust the characteristic of the displayed image based on the sensed image data.

The sensing unit may be located in the signal generating device. The sensing unit may sense data in a predetermined area of the non-volatile internal memory unit.

The foregoing and/or other aspects and utilities of the present general inventive concept may also be achieved by providing a method of controlling a display of an image by a display apparatus having a non-volatile internal memory unit having a plurality of updatable data areas to store updatable image data, and a non-updatable default area to store non-updatable reference image data, the method comprising updating data stored in a first data area of the plurality of updatable data areas based on a value of a characteristic of a displayed calibration pattern when the value of the characteristic of the displayed calibration pattern equals the predetermined setting value, determining whether the updating of the data of the first data area was successful, displaying the image using the updated data of the first data area when the updating operation was successful, and displaying the image using data of a second data area of the plurality of updatable data areas when the updating operation was unsuccessful.

The method may further comprise storing identification information identifying an updatable data area of the plurality of updatable data areas to be updated. The method may further comprise detecting the displayed calibration pattern, determining whether the value of the characteristic of the displayed calibration pattern equals the predetermined setting value, and changing the value of the characteristic of the displayed calibration pattern to be equal the predetermined setting value when the value of the characteristic of the displayed calibration pattern does not equal the predetermined setting value.

The foregoing and/or other aspects and utilities of the present general inventive concept may also be achieved by providing a method of controlling a display of an image by a display apparatus having a non-volatile internal memory unit having a plurality of updatable data areas to store updatable image data, and a non-updatable default area to store non-updatable default image data, and a storage unit to store update status information, the method comprising determining whether an update operation to update data of a first data area of the plurality of updatable data areas has successfully ended, and displaying the image using the updated data of the first data area when it is determined that the update operation has successfully ended, determining whether the update operation has been started when it is determined that the update operation has not successfully ended, and displaying the image using data of a second data area of the plurality of updatable data areas when it is determined that the update operation has not been started, determining whether the data of the first data area has a value equal to a predetermined reference value when it is determined that the update operation has been started, and storing update failure status information in the storage unit and displaying the data of the second data area when it is determined that the data of the first area has a value that does not equal the predetermined reference value, and storing update ended status information in the storage unit and displaying the image using the data of the first data area when it is determined that the data of the first area has a value that equals the predetermined reference value.

### BRIEF DESCRIPTION OF THE DRAWINGS

The above and/or other aspects and advantages of the present general inventive concept will become apparent and more readily appreciated from the following description of the embodiments, taken in conjunction with the accompanying drawings of which:

FIG. 1 is a view illustrating an example of an internal area assignment of a flash ROM and a RAM in a conventional display apparatus;

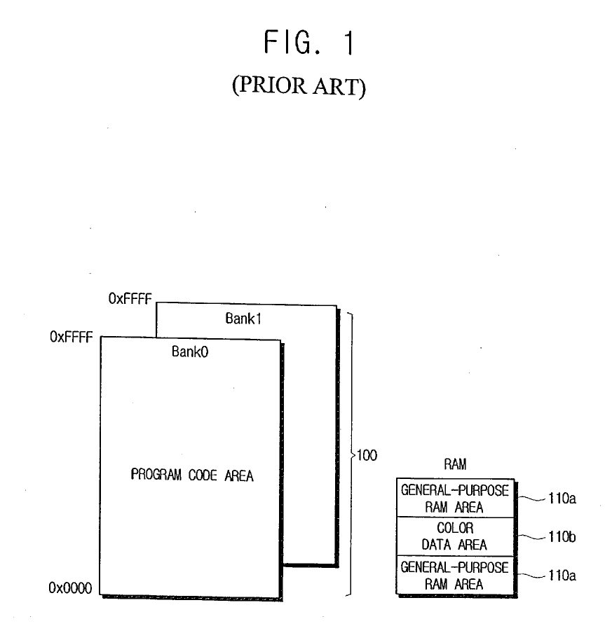

FIG. 2 is an external view illustrating a system including a display apparatus, according to an embodiment of the present general inventive concept;

FIG. 3 is a control block diagram illustrating the display apparatus of FIG. 2, according to an embodiment of the present general inventive concept;

FIG. 4 is a view illustrating an example of an internal area assignment of a flash ROM in the display apparatus of FIG. 3, according to an embodiment of the present general inventive concept;

FIG. 5 is a control flowchart illustrating a color data update control process of the display apparatus of FIG. 3, according to an embodiment of the present general inventive concept; and

FIG. 6 is a control flowchart illustrating an initial driving control process of the display apparatus of FIG. 3, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

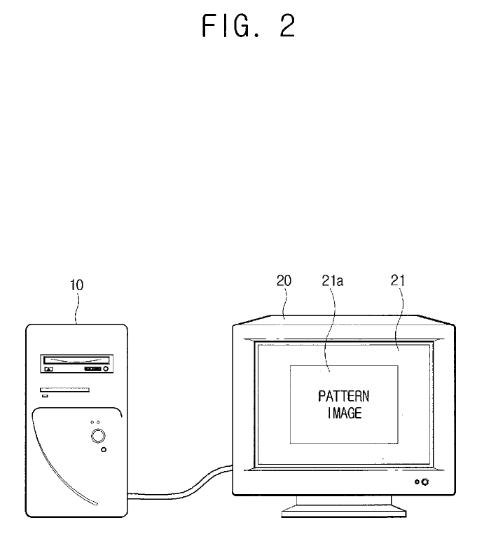

FIG. 2 is an external view illustrating a system including a display apparatus 20, according to an embodiment of the present general inventive concept. As illustrated in FIG. 2, the display apparatus 20 receives an image signal from a computer 10 as an external information processing apparatus (i.e., an image signal source) and displays an image, based on the image signal, on a display unit 21. Here, when a color adjustment pattern signal is provided from the computer 10 to the display apparatus 20, the display apparatus 20 displays a pattern image 21a, based on the pattern signal, on the display unit 21. Here, the computer 10 detects the pattern image 21a displayed on the display unit 21 and adjusts a pattern parameter of the pattern signal (i.e., a characteristic of the image, such as a color value) to make a color value of the detected pattern image 21a equal to a desired setting value. Accordingly, the computer 10 can update color data of the display apparatus 20 with color data corresponding to the pattern signal for which the color value of the detected pattern image 21 a is equal to the desired setting value.

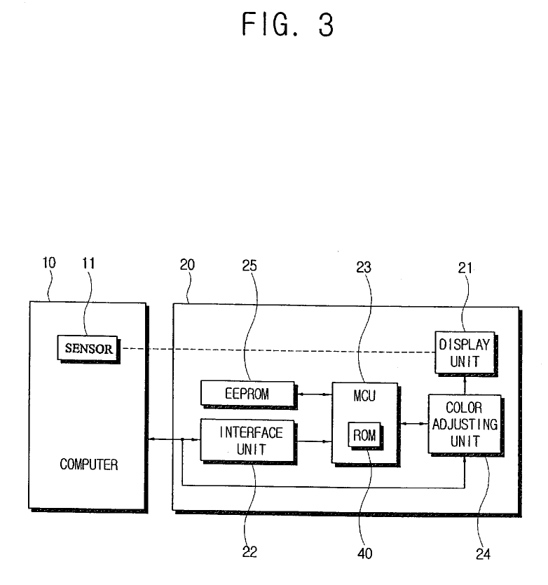

Here, a process of updating the color data of the display apparatus 20 will be described in more detail with reference to FIG. 3. As illustrated in FIG. 3, the display apparatus 20 of the present general inventive concept includes an interface unit 22 to communicate with the computer 10, a display unit 21 on which an image is displayed based on an image signal provided from the computer 10 through the interface unit 22, a color adjusting unit 24 to adjust colors of the image displayed on the display unit 21, a micro control unit (MCU) 23 to control the above-mentioned components, and an EEPROM 25 (Electrically Erasable Programmable Read Only Memory).

The micro control unit 23 contains a nonvolatile memory to store various data required for an operation of the display apparatus 20. In this embodiment, a flash ROM 40 is exemplified as the nonvolatile memory.

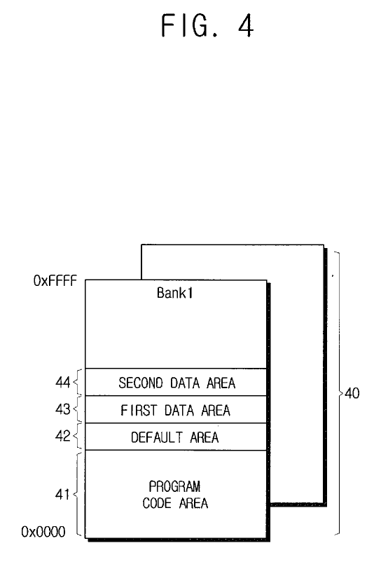

The computer 10 functions as a control apparatus to update color data stored in one of first and second data areas 43 and 44 of the flash ROM 40, as illustrated in FIG. 4. To update the color data, the computer 10 outputs a color adjustment pattern signal to the display apparatus 20.

Here, the computer 10 may include a sensor 11 to sense the pattern image 21a (illustrated in FIG. 2) displayed on the display unit 21. In this embodiment, although the sensor 11 is illustrated to be incorporated into the computer 10 in FIG. 3, the sensor 11 may be provided separately from the computer 10. In addition, the sensor 11 may be configured to locate color data in a specified area in the display apparatus 20 and to provide the located color data through a separate signal line (not illustrated) to the information processing apparatus, i.e., the computer 10 in FIG. 3.

The sensor 11 provides a detection signal regarding the color data for the pattern image 21a displayed on the display unit 21 to the computer 10. Accordingly, based on the detection signal, the computer 10 can determine whether a color value of the pattern image 21a that has undergone a process of color adjustment is equal to a desired setting value regarding a gain value (i.e., signal strength) for each color. According to a result of the determination, if colors of the pattern image 21a displayed on the display unit 21 are adjusted according to the detection signal from the sensor 11, a pattern signal to adjust a color data arrangement (i.e., a pattern parameter) according to a predetermined color adjustment file is provided to the display apparatus 20. Accordingly, the computer 10 can update the color data of the display apparatus 20 based on the color value of the pattern image 21a that is equal to the desired setting value.

Here, the color data arrangement according to the color adjustment file created in the computer 10 is recordable, i.e., updatable, in the first data area 43 in FIG. 4 and the second data area 44 in FIG. 4 of the flash ROM 40 according to a predetermined control signal. In this case, it is possible but not necessary that the control signal provided from the computer 10 to the display apparatus 20 is executed on an ISP (In_System Programming) instruction basis. In this embodiment, an operation of recording a required color data in the flash ROM 40 contained in the micro control unit 23 or of reading or deleting the color data recorded in the flash ROM 40 is performed based on ISP instructions.

The computer 10 that provides the color data according to the color adjustment file is connected to the interface unit 22 of the display apparatus 20 via a predetermined signal line. Here, the signal line and the interface unit 22 may be provided in a manner adapted to various transmission systems, such as a USB system, a serial port system, or a DDC (Display Data Channel) system. Accordingly, the color data provided from the computer 10 to terminal pins (not illustrated) provided in the interface unit 22 may be transmitted to and stored in the flash ROM 40.

In more detail, referring to FIG. 4, the flash ROM 40 includes a program code area 41 to store program codes, a default area 42 to store reference color data to adjust a display state of the image displayed on the display unit 21, and the first data area 43 and the second data area 44 to store updatable color data to adjust the display state of the image. Here, the default area 42 may not be assigned in the flash ROM 40.

Here, the reference color data of the default area 42 are basic color data stored during a manufacturing of the display apparatus 20, and cannot be adjusted or updated after shipping of the display apparatus 20. According to such reference color data, a reference color pattern may be prepared as various color profiles based on predetermined color coordinate values and may be set as a gray mode, an RGB mode, or a CYMK mode. In addition, the reference color pattern may be set as a skin color mode, a grass color mode, or a sky color mode based on skin color, grass color, or sky color.

Here, in addition to the reference color data stored in the default area 42, color data adjustable or updatable in various ways are stored in the first data area 43 and the second data area 44. Specifically, the computer 10 may update the color data stored in the first and/or second data areas 43 and 44 to generate various different color data, thus allowing the display apparatus 20 to display images of various colors to meet a variety of needs of viewers. Accordingly, since the flash ROM 40 in the micro control unit 23 can be used to store the color data to be updated as various different color data, the display apparatus 20 can increase its performance speed to perform the color adjustment without any separate memory for the color data, while displaying images of colors to meet a variety of needs of viewers.

In the following description, the color data stored in the first and second data areas 43 and 44 are described as being color calibration adjustment data. However, the present general inventive concept is not so limited, and thus the first and second data areas 43 and 44 can store other types of color data along with or instead of the color calibration adjustment data.

The color adjusting unit 24 (see FIG. 3) is a functional unit contained in an image processing unit of the display apparatus 20, to process image signals applied to the display unit 21 and to adjust a display state of, for example, color of an image displayed on the display unit 21, based on the color data stored in one of the default area 42, the first data area 43, and the second data area 44 of the flash ROM 40. In addition, under a control of the micro control unit 23, the color adjusting unit 24 can adjust the pattern image 21a displayed on the display unit 21 to have a color value according to the pattern signal provided from the computer 10. In embodiments, the color adjusting unit 24 may adjust the colors of the image displayed on the display unit 21 based on the color data stored in one of the first data area 43 and the second data area 44 and the pattern signal.

The micro control unit 23 controls the image processing unit based on the program codes stored in the flash ROM 40.

In addition, upon receiving the pattern signal from the computer 10, the micro control unit 23 controls the color adjusting unit 24 to display the pattern image 21a having a color value according to the pattern signal on the display unit 21. In addition, upon receiving the pattern signal from the computer 10, the micro control unit 23 stores name information and update start state information of a data area to be updated of the first and second data areas 43 and 44 in the EEPROM 25 of FIG. 3. In this embodiment, the micro control unit 23 stores the name information of the first data area 43 in the EEPROM 25 to update a data area (for example, the first data area 43) other than a previously updated data area (for example, the second data area 44). However, in other embodiments, the micro control unit 23 may store the name information of the first data area 43 in the EEPROM 25 to update the same data area (for example, the first data area 43) as the previously updated data area (for example, the first data area 43).

In addition, when the computer 10 determines that the color value of the pattern image 21a is equal to the desired setting value, the computer 10 updates the color data of the first data area 43 of the flash ROM 40 in the micro control unit 23 according to the above-described method. While the computer 10 is updating the color data of the first data area 43 of the flash ROM 40, the micro control unit 23 determines whether the update operation is abnormally stopped. Here, the update operation may be abnormally stopped for various reasons, such as due to an abrupt power off of the computer 10 during the update operation or an abrupt power off of the display apparatus 20 during the update operation.

Upon determining that the update operation is normally ended, the micro control unit 23 changes the update start state information stored in the EEPROM 25 to update end state information. When the update operation is normally ended and the update end state information is stored in the EEPROM 25, the micro control unit 23 controls the color adjusting unit 24 to adjust the display state of the color and the like of the image displayed on the display unit 21 based on the color data of the updated first data area 43 corresponding to the name information stored in the EEPROM 25. Accordingly, the display apparatus 20 can display the image according to the color data of the updated first data area 43.

On the other hand, upon determining that the update operation is abnormally stopped, the micro control unit 23 controls the color adjusting unit 24 to adjust the display state of the color and the like of the image displayed on the display unit 21 based on the color data stored in an area other than the first data area 43, i.e., an area that does not correspond to the name information stored in the EEPROM 25. In other words, the display apparatus 20 can display the image according to the color data stored in the remaining data area that is the second data area 44 in FIG. 4 (which has not been updated), which is an area other than the first data area 43 in which abnormal color data may be stored during the abnormally-stopped update operation.

In this manner, in the display apparatus 20 of this embodiment of the present general inventive concept, a storing area to store the color data is divided into the first data area 43 and the second data area 44, and when the color data of one of the first and second data areas 43 and 44 are updated, the remaining data area is used as a backup area. Accordingly, when it is determined that the abnormal color data are stored in one data area during the update operation, the display apparatus 20 of the present general inventive concept can display a normal image by using the color data stored in the other data area as the backup area.

Although it has been illustrated that the first data area 43 is updated and the second data area 44 is used as the backup area, the second data area 44 is updated and the first data area 43 is used as the backup area during a next color data update operation. However, the present general inventive concept is not limited to updating the first data area 43 during a first update operation. Accordingly, the second data area 44 may be updated and the first data area 43 may be used as the backup area during a first update operation, and the first data area 43 may updated and the second data area 44 may be used as the backup area during a following color data update operation. In addition, the first and second data areas 43 and 44 are not required to alternate between being updated and serving as a backup area. Thus, one of the first and second data areas 43 and 44 may be repeatedly updated during repeated update operations, while the other of the first and second data areas 43 and 44 functions as a backup area during each of the update operations.

At an initial stage of driving the display apparatus 20, the micro control unit 23 reads the update state information stored in the EEPROM 25. When the update end state information is read from the EEPROM 25, the update operation of the color data is normally ended before the driving of the display apparatus 20 stops. Accordingly, when the update end state information is read, the micro control unit 23 controls the color adjusting unit 24 to adjust the display state of the color or the like of the image displayed on the display unit 21 based on the color data of the updated first data area 43 corresponding to the name information stored in the EEPROM 25. Accordingly, the display apparatus 20 can display the image according to the color data of the updated first data area 43.

Although not necessary, the micro control unit 23 may pre-store a first reference check sum value of the first data area 43 and a second reference check sum value of the second data area 44.

Thus, at the initial stage of driving the display apparatus 20, when the update start state information is read from the EEPROM 25, the micro control unit 23 calculates a check sum value of the updated first data area 43 corresponding to the name information stored in the EEPROM 25. Then, the micro control unit 23 compares the calculated check sum value with the first reference check sum value to determine whether the updated color data of the first data area 43 are normal. If the calculated check sum value is equal to the first reference check sum value, the micro control unit 23 determines that the updated color data of the first data area 43 are normal and changes the update start state information stored in the EEPROM 25 to the update end state information. When the update end state information is stored in the EEPROM 25, the micro control unit 23 controls the color adjusting unit 24 to adjust the display state of the color or the like of the image displayed on the display unit 21 based on the color data of the updated first data area 43 corresponding to the name information stored in the EEPROM 25. Accordingly, the display apparatus 20 can display the image according to the color data of the updated first data area 43.

On the contrary, if the calculated check sum value is not equal to the first reference check sum value, the micro control unit 23 determines that the updated color data of the first data area 43 are abnormal (e.g., damaged) and changes the update start state information stored in the EEPROM 25 to update failure state information. When the update failure state information is stored in the EEPROM 25, the micro control unit 23 controls the color adjusting unit 24 to adjust the display state of the color or the like of the image displayed on the display unit 21 based on the color data stored in the second data area 44 (i.e., the backup area, which has not been updated) that does not correspond to the name information stored in the EEPROM 25. Accordingly, the display apparatus 20 can display the image according to the color data stored in the remaining data area that is the second data area 44 in FIG. 4 (which has not been updated), which is an area other than the first data area 43 in which abnormal color data may be stored during the failed update operation.

At the initial stage of driving of the display apparatus 20, when the update failure state information is read from the EEPROM 25 or information other than the update start state information and the update end state information is read from the EEPROM 25, the micro control unit 23 controls the color adjusting unit 24 to adjust the display state of the color or the like of the image displayed on the display unit 21 based on the color data stored in the second data area 44 (i.e., the backup area, which has not been updated) that does not correspond to the name information stored in the EEPROM 25. Accordingly, the display apparatus 20 can display the image according to the color data stored in the remaining data area that is the second data area 44 in FIG. 4 (which has not been updated), which is an area other than the first data area 43 in which abnormal color data may be stored during the failed update operation.

In this manner, in the display apparatus 20 of this embodiment of the present general inventive concept, a storing area to store the color data is divided into the first data area 43 and the second data area 44, and when the color data of one of the first and second data areas 43 and 44 are updated, the remaining data area is used as a backup area. Accordingly, when it is determined that abnormal color data are stored in one data area during the update operation, the display apparatus 20 of the present general inventive concept can display a normal image by using the color data stored in the other data area as the backup area.

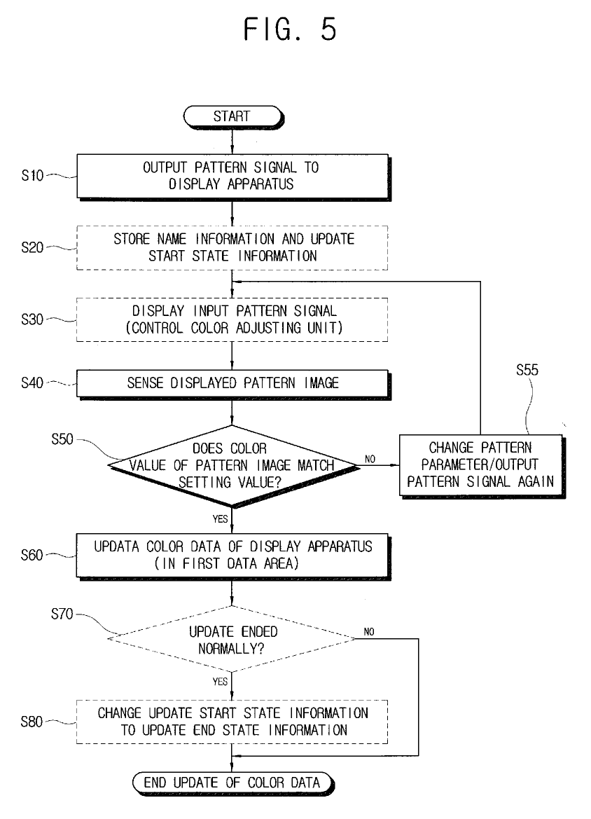

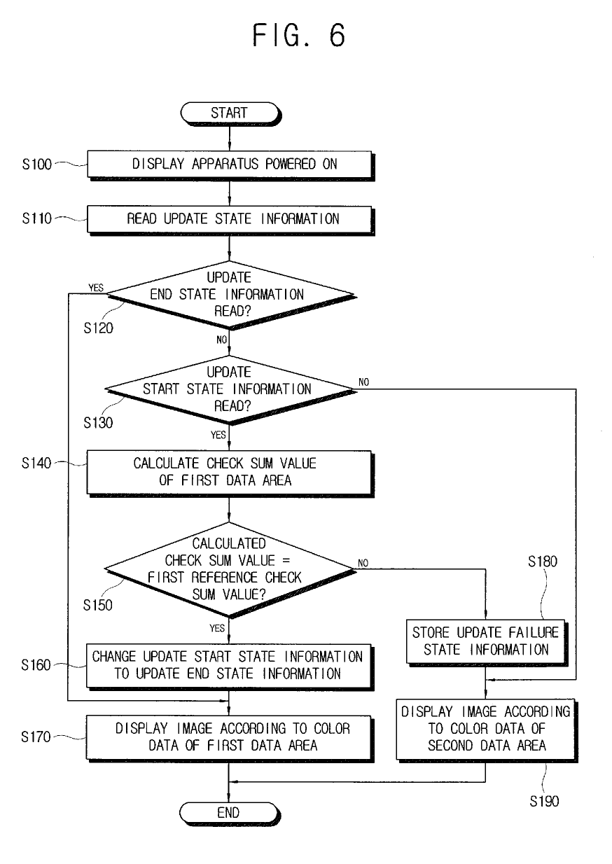

Hereinafter, a color data update control process and an initial driving control process of the display apparatus 20 of and embodiment of the present general inventive concept will be described with reference to FIGS. 5 and 6. In the following description, the color data stored in the first and second data areas 43 and 44 are described as being color calibration adjustment data. However, the present general inventive concept is not so limited, and thus the second data areas 43 and 44 can store other types of color data along with or instead of the color calibration adjustment data.

The color data update control process of the display apparatus 20 will be described with reference to FIG. 5. For the purpose of convenience, operations depicted by a solid line in FIG. 5 are performed by the computer 10 in this embodiment, and operations depicted by a dotted line in FIG. 5 are performed by the display apparatus 20 in this embodiment.

The computer 10 outputs a pattern signal to execute a color calibration to the display apparatus 20 at operation S10. Upon receiving the pattern signal from the computer 10, the display apparatus 20 stores name information and update start state information of a data area to be updated of the first data area 43 and the second data area 44 in the EEPROM 25 at operation S20. Here, an updating of the first data area 43 (as opposed to the second data area 44) will be described as an example. However, the second data area 44 may instead be the data area to be updated. Upon receiving the pattern signal from the computer 10, the display apparatus 20 controls the color adjusting unit 24 to display the pattern image 21a having a color value according to the pattern signal on the display unit 21 at operation S30.

At this time, the sensor 11 provides a detection signal to sense the pattern image 21a displayed on the display unit 21 to the computer 10 at operation S40. Based on the detection signal provided by the sensor 11, the computer 10 determines whether the color value of the pattern image 21a matches a desired setting value at operation S50. If it is determined that the color value of the pattern image 21 a does not match the desired setting value, and thus, colors of the pattern image 21a should be adjusted, a pattern signal to adjust a pattern parameter of the pattern image 21a is provided by the computer 10 to the display apparatus 20 at operation S55. When the color value of the pattern image 21a matches the desired setting value through initially or through repetition of operations S30 through S50, the computer 10 transmits color data according to an execution result of the color calibration to the display apparatus 20. The micro control unit 23 of the display apparatus 20 updates the first data area 43 of the flash ROM 40 with the color data from the computer 10 at operation S60.

In this manner, while the computer 10 is updating the color data of the first data area 43 of the flash ROM 40, or after the computer 10 is finished updating the color data of the first data area 43 of the flash ROM 40, the micro control unit 23 determines whether the update operation is normally ended at operation S70. Upon determining that the update operation is normally ended, the micro control unit 23 changes the update start state information stored in the EEPROM 25 to the update end state information at operation S80. Accordingly, the color data update operation is normally ended, and the micro control unit 23 controls the color adjusting unit 24 to display the image according to the color data of the updated first data area 43.

However, the update operation may be automatically ended if any erroneous operations occur, such as an abrupt power off of the computer 10 during the update operation or an abrupt power off of the display apparatus 20 during the update operation (i.e., an abnormal end of the operation). Although not illustrated in FIG. 5, if the update operation is abnormally-ended, the micro control unit 23 controls the color adjusting unit 24 to display the image according to the color data of the second data area 44, which was not updated and which is the backup area.

The initial driving control process of the display apparatus 20 will be described with reference to FIG. 6.

When the display apparatus 20 is powered on at operation S100 at an initial stage of driving the display apparatus 20, the micro control unit 23 reads update state information stored in the EEPROM 25 at operation S110. The micro control unit 23 determines whether the update end state information is read from the EEPROM 25 at operation S120. When the update end state information is ended, the micro control unit 23 determines that an update operation of color data is normally ended before the driving of the display apparatus 20 stops. Accordingly, when the update end state information is read, the micro control unit 23 controls the color adjusting unit 24 to adjust a display state of color or the like of an image displayed on the display unit 21 based on the color data of the updated first data area 43 corresponding to the name information stored in the EEPROM 25 at operation S170. Accordingly, the display apparatus 20 can display the image according to the color data of the updated first data area 43.

On the contrary, when the update end state information is not read from the EEPROM 25, the micro control unit 23 determines whether update start state information is read from the EEPROM 25 at operation S130. Upon determining that the update start state information is read from the EEPROM 25, the micro control unit 23 calculates a check sum value of the updated first data area 43 corresponding to the name information stored in the EEPROM 25 at operation S140. Then, the micro control unit 23 compares the calculated check sum value with a first reference check sum value to determine whether the updated color data of the first data area 43 are normal at operation S150. If the calculated check sum value is equal to the first reference check sum value, the micro control unit 23 determines that the updated color data of the first data area 43 are normal and changes the update start state information stored in the EEPROM 25 to the update end state information at operation S160. When the update end state information is stored in the EEPROM 25, the micro control unit 23 controls the color adjusting unit 24 to adjust the display state of the color or the like of the image displayed on the display unit 21 based on the color data of the updated first data area 43 corresponding to the name information stored in the EEPROM 25 at operation S170. Accordingly, the display apparatus 20 can display the image according to the color data of the updated first data area 43.

However, when the calculated check sum value is not equal to the first reference check sum value at operation S150, the micro control unit 23 determines that the updated color data of the first data area 43 are abnormal (e.g., damaged) and changes the update start state information stored in the EEPROM 25 to update failure state information at operation S180. When the update failure state information is stored in the EEPROM 25, the micro control unit 23 controls the color adjusting unit 24 to adjust the display state of the color or the like of the image displayed on the display unit 21 based on the color data stored in the second data area 44 (which was not updated) at operation S190. Accordingly, the display apparatus 20 can display the image according to the color data stored in the remaining data area that is the second data area 44 (which was not updated), which is an area other than the first data area 43 in which abnormal color data may be stored during the abnormal update operation.

Moreover, when it is determined at operation S130 that the update start state information is not read from the EEPROM 25 (or, although not illustrated in FIG. 6, when it is determined that the update failure state information is read from the EEPROM 25 or information other than the update start state information and the update end state information is read from the EEPROM 25), the micro control unit 23 controls the color adjusting unit 24 to adjust the display state of the color or the like of the image displayed on the display unit 21 based on the color data stored in the second data area 44 that does not correspond to the name information stored in the EEPROM 25 at operation 190. Accordingly, the display apparatus 20 can display the image according to the color data stored in the remaining data area that is the second data area 44 (which was not updated), which is an area other than the first data area 43 in which abnormal color data may be stored during the abnormal update operation.

As described above, in the display apparatus 20 and the control method thereof according to embodiments of the present general inventive concept, the first and second data areas 43 and 44 in which the color data are stored are assigned in the nonvolatile memory 40, thus increasing an execution speed of a color adjustment and simplifying the display apparatus 20 without any separate external memory.

In addition, in the display apparatus 20 and the control method thereof according to embodiments of the present general inventive concept, a storing area of color data in the nonvolatile memory 40 is divided into the first data area 43 and the second data area 44, and when the color data of one of the first and second data areas 43 and 44 are updated, the remaining data area is used as a backup area. Accordingly, when it is determined that abnormal color data are stored in one data area during an update operation, the display apparatus 20 can display a normal image by using the color data stored in the other data area as the backup area.

Various embodiments of the present general inventive concept provide a simplified display apparatus without any separate external memory, in which a performance speed of a color adjustment is increased by assigning a color data area in a nonvolatile memory provided in a micro control unit, and a control method thereof.

In addition, various embodiments of the present general inventive concept provide a display apparatus in which, if one of first and second data areas in which color data are stored is abnormally updated, color data stored in the other data area corresponding to a backup area are used to display normal images, and a control method thereof.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus to display an image corresponding to an image signal provided from an external information processing apparatus, comprising:
a nonvolatile memory comprising a first data area and a second data area to store data to adjust a display state of the displayed image, and a program code area to store program codes;
an image processing unit to process the image signal based on the data stored in one of the first data area and the second data area; and
a micro control unit to control the image processing unit to process the image signal based on the data stored in the other of the first data area and the second data area when the data stored in the one of the first data area and the second data area are updated in an update operation that is abnormally ended.

2. The display apparatus according to claim 1, wherein the nonvolatile memory comprises a flash ROM.

3. The display apparatus according to claim 2, wherein the flash ROM is provided in the micro control unit.

4. The display apparatus according to claim 1, wherein the data stored in the first data area and the second data area are predetermined color data.

5. The display apparatus according to claim 4, wherein the micro control unit updates the color data stored in one of the first data area and the second data area by the external information processing apparatus.

6. The display apparatus according to claim 4, further comprising:
a predetermined memory,
wherein the micro control unit stores name information and update start state information of a data area to be updated of the first data area and the second data area in the predetermined memory when a pattern signal to update the color data stored in the data area to be updated is provided from the external information processing apparatus.

7. The display apparatus according to claim 6, wherein the micro control unit controls the image processing unit to process the image signal based on the pattern signal.

8. The display apparatus according to claim 6, wherein the predetermined memory is an EEPROM.

9. The display apparatus according to claim 8, wherein the micro control unit determines whether the update operation is normally ended when the update of the color data is ended, and changes update start state information stored in the EEPROM to update end state information when it is determined that the update operation is normally ended.

10. The display apparatus according to claim 9, wherein the micro control unit controls the image processing unit to process the image signal based on the data of the updated data area corresponding to the name information stored in the EEPROM when the update end state information is stored in the EEPROM.

11. The display apparatus according to claim 10, wherein the micro control unit controls the image processing unit to process the image signal based on the data of the other data area that is not updated when it is determined that the update operation is abnormally ended.

12. The display apparatus according to claim 9, wherein the micro control unit controls the image processing unit to process the image signal based on the color data of the updated data area corresponding to the name information stored in the EEPROM when the update end state information is read from the EEPROM at an initial driving stage.

13. The display apparatus according to claim 9, wherein the micro control unit pre-stores a first reference check sum value of the first data area and a second reference check sum value of the second data area, calculates a check sum value of the updated data area corresponding to the name information stored in the EEPROM when the update start state information is read from the EEPROM at an initial driving stage, and changes the update start state information stored in the EEPROM to the update end state information when the calculated check sum value is equal to a corresponding one of the first and second reference check sum values.

14. The display apparatus according to claim 13, wherein the micro control unit changes the update start state information stored in the EEPROM to update failure state information when the calculated check sum value is not equal to the corresponding one of the first and second reference check sum values.

15. The display apparatus according to claim 14, wherein the micro control unit controls the image processing unit to process the image signal based on the data of the other data area that is not updated when the update failure state information is stored in the EEPROM.

16. The display apparatus according to claim 14, wherein the micro control unit controls the image processing unit to process the image signal based on the data of the other data area that is not updated when the update failure state information is read from the EEPROM at the initial driving stage.

17. A control method of a display apparatus to display an image corresponding to an image signal provided from an external information processing apparatus, the display apparatus having a nonvolatile memory including a first data area and a second data area to store data to adjust a display state of the displayed image and a program code area to store program codes, and an image processing unit to process the image signal, the control method comprising:
updating the data stored in one of the first data area and the second data area;
determining whether the update operation is abnormally ended; and
controlling the image processing unit to process the image signal based on the data stored in the other of the first data area and the second data area when the update operation is determined to be abnormally ended.

18. The control method according to claim 17, wherein the nonvolatile memory comprises a flash ROM.

19. The control method according to claim 18, wherein the flash ROM is provided in a micro control unit.

20. The control method according to claim 17, wherein the data stored in the first data area and the second data area are predetermined color data.

21. The control method according to claim 20, wherein the display apparatus further includes a predetermined memory, the method further comprising:
determining whether a pattern signal to update the data stored in the one of the first data area and the second data area is provided from the external information processing apparatus; and
storing name information and update start state information of a data area to be updated of the first data area and the second data area in the predetermined memory when the pattern signal is provided.

22. The control method according to claim 21, further comprising:
controlling the image processing unit to process the image signal based on the pattern signal when the pattern signal is provided.

23. The control method according to claim 21, wherein the predetermined memory is an EEPROM.

24. The control method according to claim 23, wherein the updating of the data comprises:
updating the data stored in the one of the first data area and the second data area by the external information processing apparatus.

25. The control method according to claim 24, further comprising:
changing the update start state information stored in the EEPROM to update end state information when it is determined that the update operation is normally ended.

26. The control method according to claim 25, further comprising:
controlling the image processing unit to process the image signal based on the data of the updated data area corresponding to the name information stored in the EEPROM when the update end state information is stored in the EEPROM.

27. The control method according to claim 25, further comprising:
reading an update state information stored in the EEPROM at an initial driving stage; and
controlling the image processing unit to process the image signal based on the data of the updated data area corresponding to the name information stored in the EEPROM when the update end state information is read from the EEPROM.

28. The control method according to claim 27, further comprising:
pre-storing a first reference check sum value of the first data area and a second reference check sum value of the second data area;
calculating a check sum value of the updated data area corresponding to the name information stored in the EEPROM when the update start state information is read from the EEPROM at the initial driving stage;
determining whether the calculated check sum value is equal to a corresponding one of the first and second reference check sum values; and
changing the update start state information stored in the EEPROM to the update end state information when it is determined that the calculated check sum value is equal to the corresponding one of the first and second reference check sum values.

29. The control method according to claim 28, further comprising:
changing the update start state information stored in the EEPROM to update failure state information when it is determined that the calculated check sum value is not equal to the corresponding one of the first and second reference check sum values.

30. The control method according to claim 29, further comprising:
controlling the image processing unit to process the image signal based on the data of the other data area that is not updated when the update failure state information is stored in the EEPROM.

31. The control method according to claim 29, further comprising:
controlling the image processing unit to process the image signal based on the data of the other data area that is not updated when the update failure state information is read from the EEPROM at the initial driving stage.

32. A display apparatus to display an image, comprising:
a non-volatile internal memory unit having a plurality of updatable data areas to store updatable image data, and a non-updatable default area to store non-updatable reference image data; and
an adjusting unit to adjust a characteristic of the displayed image using the updatable image data stored in one of the plurality of updatable data areas of the non-volatile internal memory unit.

33. The display apparatus according to claim 32, wherein the adjusting unit adjusts the characteristic of the displayed image using updated data from a first data area of the plurality of updatable data areas when the first data area has been successfully updated, and using non-updated data from a second data area of the plurality of updatable data areas when the first data area has been unsuccessfully updated.

34. The display apparatus according to claim 32, wherein the characteristic to be adjusted is a color characteristic.

35. The display apparatus according to claim 32, further comprising:
a micro control unit to control the adjusting unit to adjust the characteristic of the displayed image,
wherein the non-volatile internal memory unit includes a program code area to store a program code, and the micro control unit controls the adjusting unit using the program code stored in the program code area of the non-volatile internal memory unit.

36. The display apparatus according to claim 35, wherein the non-volatile internal memory unit is located in the micro control unit.

37. The display apparatus according to claim 32, further comprising:
a storage unit to store identification information corresponding to an updatable data area of the plurality of updatable data areas to be updated.

38. A display system to display an image, comprising:
a display device to process an image signal corresponding to the image, the display device comprising:
a non-volatile internal memory unit having a plurality of updatable data areas to store updatable image data, and a non-updatable default area to store non-updatable reference image data, and
an adjusting unit to adjust a characteristic of the displayed image using the updatable image data stored in one of the plurality of updatable data areas of the non-volatile internal memory unit;
an external signal generating device to generate the image signal; and
a sensing unit to sense image data corresponding to the characteristic to be adjusted in the non-volatile internal memory unit, and to generate a signal to adjust the characteristic of the displayed image based on the sensed image data.

39. The display system according to claim 38, wherein the sensing unit is located in the signal generating device.

40. The display system according to claim 38, wherein the sensing unit senses data in a predetermined area of the non-volatile internal memory unit.

41. A method of controlling a display of an image by a display apparatus having a non-volatile internal memory unit having a plurality of updatable data areas to store updatable image data, and a non-updatable default area to store non-updatable reference image data, the method comprising:
updating data stored in a first data area of the plurality of updatable data areas based on a value of a characteristic of a displayed calibration pattern when the value of the characteristic of the displayed calibration pattern equals the predetermined setting value;
determining whether the updating of the data of the first data area was successful;
displaying the image using the updated data of the first data area when the updating operation was successful; and
displaying the image using data of a second data area of the plurality of updatable data areas when the updating operation was unsuccessful.

42. The method according to claim 41, further comprising:
storing identification information identifying an updatable data area of the plurality of updatable data areas to be updated.

43. The method according to claim 41, further comprising:
detecting the displayed calibration pattern;
determining whether the value of a characteristic of the displayed calibration pattern equals the predetermined setting value; and
changing the value of the characteristic of the displayed calibration pattern to be equal the predetermined setting value when the value of the characteristic of the displayed calibration pattern does not equal the predetermined setting value.

44. A method of controlling a display of an image by a display apparatus having a non-volatile internal memory unit having a plurality of updatable data areas to store updatable image data, and a non-updatable default area to store non-updatable default image data, and a storage unit to store update status information, the method comprising:
determining whether an update operation to update data of a first data area of the plurality of updatable data areas has successfully ended, and displaying the image using the updated data of the first data area when it is determined that the update operation has successfully ended;
determining whether the update operation has been started when it is determined that the update operation has not successfully ended, and displaying the image using data of a second data area of the plurality of updatable data areas when it is determined that the update operation has not been started;
determining whether the data of the first data area has a value equal to a predetermined reference value when it is determined that the update operation has been started, and storing update failure status information in the storage unit and displaying the data of the second data area when it is determined that the data of the first area has a value that does not equal the predetermined reference value; and
storing update ended status information in the storage unit and displaying the image using the data of the first data area when it is determined that the data of the first area has a value that equals the predetermined reference value.
